(19) United States
(12) Patent Application Publication
(10) Pub. No.: US 2012/0203425 A1
(43) Pub. Date: Aug. 9, 2012

(54) VALVE IDENTIFICATION INFORMATION REGISTRATION SYSTEM

(75) Inventor: Yuuji SHIBAGAKI, Aichi (JP)

(73) Assignee: KABUSHIKI KAISHA TOKAI RIKA DENKI SEISAKUSHO, Aichi (JP)

(21) Appl. No.: 13/361,364

(22) Filed: Jan. 30, 2012

(30) Foreign Application Priority Data
Feb. 8, 2011 (JP) 2011-025128

(51) Int. Cl. B60C 23/00

(52) U.S. Cl. 701/36

(57) ABSTRACT

A valve identification information registration system includes a door sensor that detects an open vehicle door. A transmitter is arranged in a vehicle to transmit a tire valve activation signal when the door sensor detects the open door. A tire valve is attached to a vehicle tire and activated by the tire valve activation signal that emanates from the vehicle from the open door and transmits a response signal including identification information. A registration control circuit receives the response signal from the tire valve and registers the identification information of the tire valve included in the received wireless response signal in association with a tire location corresponding to the detection of the door sensor.

### CROSS-REFERENCE TO RELATED APPLICATIONS

This application is based upon and claims the benefit of priority from prior Japanese Patent Application No. 2011-025128, filed on Feb. 8, 2011, the entire contents of which are incorporated herein by reference.

### BACKGROUND

The present invention relates to a valve identification information registration system that registers valve identification information, used in a tire pressure monitoring system, in a vehicle.

In the prior art, tire pressure monitoring systems (TPMS) have been installed in vehicles. Such tire pressure monitoring systems perform wireless communication with tire sensors, which are integrated with tire valves, to obtain the air pressure and temperature of corresponding tires when vehicles are traveling. In this manner, the tire pressure monitoring systems monitor tires for abnormalities.

A conventional tire pressure monitoring system includes a vehicle receiver and a vehicle controller. The vehicle receiver is capable of receiving a wireless signal from the tire sensor. The vehicle controller displays the air pressure and temperature, which are contained in received wireless signal, and issues a warning when there is an abnormality.

In the conventional tire pressure monitoring system, valve identification information of each of the vehicle's tire valves is registered beforehand in the vehicle controller. Each tire valve transmits a wireless signal, which includes the valve identification information and air pressure. Based on the registered valve identification information, the vehicle controller determines whether or not the received wireless signal was transmitted from a tire valve attached to a tire of its vehicle. The valve identification information is registered in the vehicle controller when installing the tire monitoring system in the vehicle or when changing tires (refer to, for example, Japanese Laid-Open Patent Publication No. 2004-58964).

The valve identification information registration system described in the '964 publication uses a door antenna that is arranged in each door to transmit a wireless signal to the exterior of the vehicle. The door antennas transmit activation signals to activate the tire valves in a predetermined order. When a door antenna transmits an activation signal, the tire valve located near the door antenna responds to the activation signal and returns valve identification information, which is registered in the vehicle controller.

The valve identification information registration system of the '964 publication is configured under the assumption that the number of antennas installed in the vehicle is the same as the number of tires. Hence, when an antenna is installed in only the driver side door or only the driver side door and passenger side door, the tires of the vehicle cannot be all located. As a result, the valve identification information for every one of the tires cannot be registered.

### SUMMARY

One aspect of the present invention is a valve identification information registration system that registers identification information of a tire valve of a vehicle to a controller for a tire pressure monitoring system of the vehicle. The valve identification information registration system includes a door sensor that detects an open state and closed state of a door of the vehicle. A transmitter is arranged in an interior of a vehicle. The transmitter transmits a tire valve activation signal in response to a detection of the door sensor indicating that the door is in the open state. A registration control circuit receives a wireless response signal transmitted from the tire valve activated by the tire valve activation signal, which emanates from the vehicle interior from the open door. The registration control circuit registers the identification information of the tire valve, which is included in the received wireless response signal in association with a tire location corresponding to the detection of the door sensor.

Another aspect of the present invention is a valve identification information registration system including a door sensor that detects an open state and closed state of a vehicle door. A transmitter arranged in an interior of a vehicle and transmits a tire valve activation signal in response to a detection of the door sensor indicating that the door is in the open state. A tire valve attached to a tire of the vehicle is activated by the tire valve activation signal, which emanates from the vehicle interior from the open door, and transmits a wireless response signal including identification information. A registration control circuit receives the wireless response signal transmitted from the tire valve and registers the identification information of the tire valve, which is included in the received wireless response signal, in association with a tire location corresponding to the detection of the door sensor.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1A and 1B illustrate a schematic block diagram of a tire pressure monitoring system, valve identification information registration system, and electronic key system;

FIG. 2 is a plan view showing communication areas of a vehicle used by the valve identification information registration system and electronic key system;

FIG. 3 is a chart showing the reception of a detection in response to an activation signal when a door opens;

FIGS. 4A and 4B illustrate a flowchart showing the registration of valve identification information in the valve identification information registration system; and

FIG. 5 is a flowchart showing part of the registration of the valve identification information in the valve identification information registration system.

### DESCRIPTION OF THE EMBODIMENTS

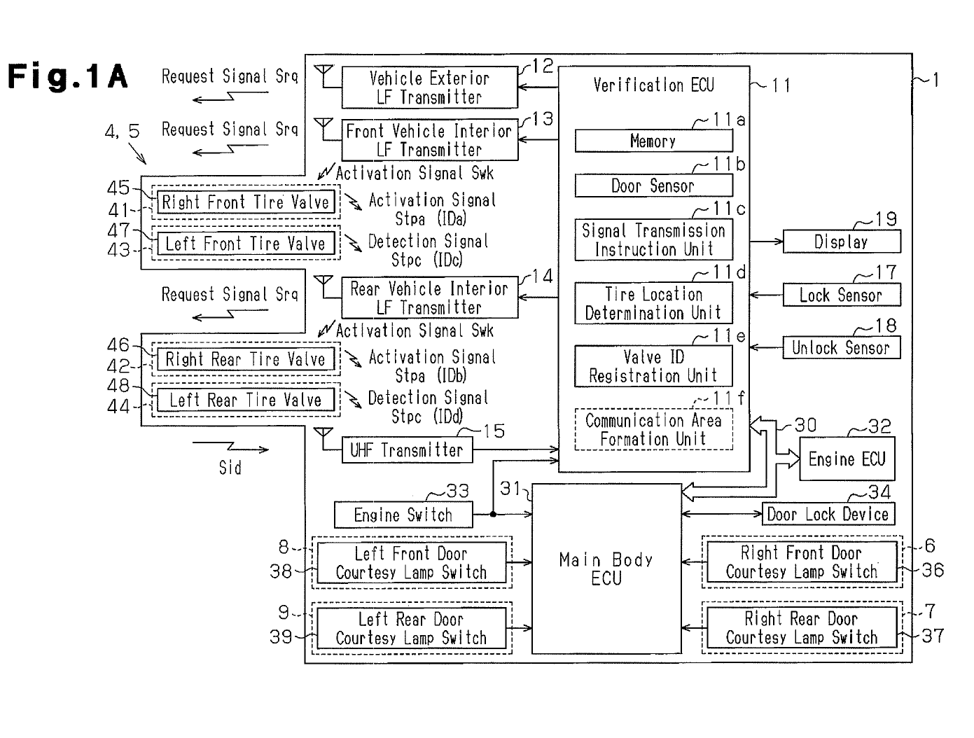

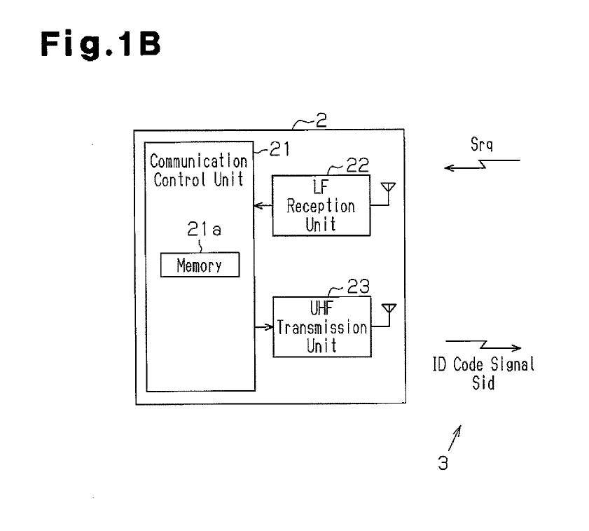

A valve identification information registration system 5 according to one embodiment of the present invention will now be described with reference to FIGS. 1 to 4.

As shown in FIGS. 1A and 1B, a vehicle 1 includes an electronic key system 3. The electronic key system 3 performs wireless communication with an electronic key 2 to operate a door lock device 34 and start or stop the engine. A user only needs to carry the electronic key 2 and does not need to manually operate the electronic key 2. The electronic key 2 transmits a unique ID code through wireless communication. The electronic key system 3 carries out ID verification by performing short range wireless communication (with a communication range of several meters) between the electronic key 2 and the vehicle 1.

The vehicle 1 includes a tire pressure monitoring system (TPMS) 4, which monitors the tire pressures of tires 41, 42, 43, and 44. The electronic key system 3 and the tire pressure monitoring system 4 share the same control unit and radio wave transmitter-receiver unit. The electronic key 2 is one example of a communication terminal. The door lock device 34 and the engine are examples of vehicle on-board devices.

The vehicle 1 includes a verification electronic control unit (ECU) 11 and a main body ECU 31. The verification ECU 11 controls the electronic key system 3 and the tire pressure monitoring system 4. The main body ECU 31 manages a power supply system of the vehicle 1. A vehicle exterior LF transmitter 12 is arranged in a right front door 6 (driver side door), a left front door 8 (passenger side door), and a trunk door of the vehicle 1. Each vehicle exterior LF transmitter 12 transmits a radio wave on the low frequency (LF) band to the vehicle exterior. A front vehicle interior LF transmitter 13 transmits a radio wave on the LF band to the front side of the vehicle interior. A rear vehicle interior LF transmitter 14 transmits a radio wave on the LF band to the rear side of the vehicle interior. The vehicle interior LF transmitters 13 and 14 are both arranged in the vehicle interior. A UHF receiver 15 is arranged in an instrument panel 40 in front of the driver seat and receives a radio wave on the ultrahigh frequency (UHF) band. The vehicle exterior LF transmitter 12, the vehicle interior LF transmitter 13 and 14, and the UHF receiver 15 are connected to the verification ECU 11. The verification ECU 11, the main body ECU 31, which, for example, manages the operation of the door lock device 34, and an engine ECU 32 are connected to an in-vehicle local area network (LAN) 30. The verification ECU 11 is one example of a controller. The front vehicle interior LF transmitter 13 is one example of a front transmitter or transmitter. The rear vehicle interior LF transmitter 14 is one example of a rear transmitter or transmitter. The UHF receiver 15 is one example of a receiver.

The electronic key 2 includes a communication control unit 21. The communication control unit 21 includes a memory 11a, which stores an ID code unique to the electronic key 2. The communication control unit 21 is connected to an LF reception unit 22 and a UHF transmission unit 23. The LF reception unit 22 receives a radio wave on the LF band. The UHF transmission unit 23 transmits a radio wave on the UHF band in accordance with a command from the communication control unit 21.

The right front door 6, left front door 8, and trunk door each include a lock sensor 17 and an unlock sensor 18. The lock sensor 17 is operated when the user locks the corresponding door. The unlock sensor 18 is operated when the user unlocks the corresponding door.

When the electronic key 2 is located outside the vehicle 1, the verification ECU 11 attempts to establish smart communication by intermittently transmitting a request signal Srq to a vehicle exterior communication area Ao from the vehicle exterior LF transmitter 12. When the electronic key 2 receives the request signal Srq with the LF reception unit 22, the electronic key 2 returns an ID code signal Sid, which contains the ID code registered in its memory 21a, from the UHF transmission unit 23. Then, the verification ECU 11 verifies the ID code of the received ID code signal Sid with the ID code registered in its memory 11a. When this vehicle exterior ID verification is successful, the verification ECU 11 determines that the electronic key 2 is located outside the vehicle 1 and permits the main body ECU 31 to perform door unlocking. In response to a detection signal from the unlock sensor 18, the main body ECU 31 drives the door lock device 34 and unlocks the doors. In this manner, to unlock the doors, the user only needs to carry the electronic key 2, approach the vehicle 1, and touch the unlock sensor 18.

When the user gets out of the vehicle 1 and touches the lock sensor 17, the verification ECU 11 attempts to establish smart communication in response to a detection signal from the lock sensor 17. When the vehicle exterior verification succeeds, the verification ECU 11 instructs the main body ECU 31 to lock the doors. In this manner, to lock the doors, the user only needs to carry the electronic key 2 when getting out of the vehicle 1 and touch the lock sensor 17. In a preferred example, the verification ECU 11 responds to a detection signal from the lock sensor and first performs vehicle exterior verification to check whether the electronic key 2 is located outside the vehicle 1. After succeeding in vehicle exterior verification, the verification ECU 11 performs ID verification inside the vehicle (vehicle interior verification) to check whether the electronic key 2 was left in the vehicle interior. When the vehicle interior verification is not successful, the verification ECU 11 determines that the electronic key 2 was not left in the vehicle interior and instructs the main body ECU 31 to unlock the doors.

After the verification ECU 11 succeeds in ID verification in the vehicle interior, the engine ECU 32 performs ignition control and fuel injection control on the engine. An engine switch 33, which is operated to switch the power state (power position) of the vehicle 1, is arranged near the drive seat. The engine switch 33 is connected to the verification ECU 11 and the main body ECU 31.

When the engine switch 33 is pushed, the verification ECU 11 transmits a request signal Srq from the front vehicle interior LF transmitter 13 and the rear vehicle interior LF transmitter 14 to perform ID verification inside the vehicle 1. When ID verification is successful, the verification ECU 11 determines that the electronic key 2 is located inside the vehicle 1.

When the verification ECU 11 determines that vehicle interior verification has succeeded, the main body ECU 31 permits switching of the power state in accordance with the operation of the engine switch 33. When the electronic key 2 is located inside the vehicle 1, the main body ECU 31 switches the power state whenever the engine switch 33 is pushed in the order of ACC ON, IG ON, and power OFF. When the electronic key 2 is located inside the vehicle 1, the engine is stopped, and the brake pedal is depressed, the verification ECU 11 instructs the engine ECU 32 to start the engine when the engine switch 33 is pushed.

The tires 41, 42, 43, and 44 of the vehicle 1 respectively include tire valves 45, 46, 47, and 48, which detect the state of the corresponding tire such as the air pressure. Each of the tire valves 45, 46, 47, and 48 includes a pressure sensor, a temperature sensor, an acceleration sensor, a UHF transmitter, and a controller that controls these components. Each of the tire valves 45, 46, 47, and 48 transmits a detection signal Stp, which corresponds to the acceleration detected by the acceleration sensor, on a UHF band radio wave. The tire valves 45, 46, 47, and 48 transmit detection signals Stp in a predetermined order. Each of the valves 45, 46, 47, and 48 may transmit the detection signal Stp in response to an activation signal Swk. The detection signal Stp includes the air pressure and temperature of the corresponding tire and the identification information (valve ID) of the corresponding tire valve. The acceleration sensor detects acceleration in the radial direction of the tire to detect tire rotation.

A display 19 is arranged near the driver seat in the vehicle 1 to display the state, such as the air pressure, of the tires 41, 42, 43, and 44. When the UHF receiver 15 receives a detection signal Stp from the tire valves 45, 46, 47, and 48, the verification ECU 11 verifies the valve ID of the received detection signal Stp with valve IDs registered in its memory 11a. When the valve verification is successful, the verification ECU 11 displays the air pressure and temperature of the tire that was successful in valve verification on the display 19.

The tire pressure monitoring system 4 includes a valve identification information registration system 5 that determines the tires 41, 42, 43, and 44 corresponding to the valve IDs of the tire valves 45, 46, 47, and 48 and then registers the valve IDs. When any one of the doors 6, 7, 8, and 9 opens, the valve identification information registration system 5 emanates an activation signal Swk to the vehicle exterior from the open door. The leaked activation signal Swk activates a desired one of the tire valves. Then, the valve identification information registration system 5 registers a valve ID in correspondence with a tire location based on the detection signal Stp returned from the activated tire valve.

The verification ECU 11 includes a door sensor 11b, which detects the open state and closed state of each of the doors 6, 7, 8, and 9. The door sensor 11b may obtain an open door signal from door courtesy lamp switches 36, 37, 38, and 39 to detect the open and closed states of each of the doors 6, 7, 8, and 9. Each of the door courtesy lamp switches 36, 37, 38, and 39 provide the main body ECU 31 with an open door signal when the corresponding one of the doors 6, 7, 8, and 9 opens. The door courtesy lamp switches 36, 37, 38, and 39 are respectively arranged in the doors 6, 7, 8, and 9.

The verification ECU 11 includes a signal transmission instruction unit 11c. During registration of the valve ID, the signal transmission instruction unit 11c transmits an activation signal Swk from the front vehicle interior LF transmitter 13 or the rear vehicle interior LF transmitter 14 in accordance with the locations of the open doors 6, 7, 8, and 9. For example, when the front door 6 or 8 opens, the signal transmission instruction unit 11c transmits the activation signal Swk from the front vehicle interior LF transmitter 13 and receives a detection signal Stp, which is transmitted in response to the activation signal Swk. When the rear door 7 or 9 opens, the signal transmission instruction unit 11c transmits the activation signal Swk from the rear vehicle interior LF transmitter 14 and receives a detection signal Stp, which is transmitted in response to the activation signal Swk. The front vehicle interior LF transmitter 13 transmits the activation signal Swk to a front interior verification communication area Aif. The rear vehicle interior LF transmitter 14 transmits the activation signal Swk to a rear interior verification communication area Air.

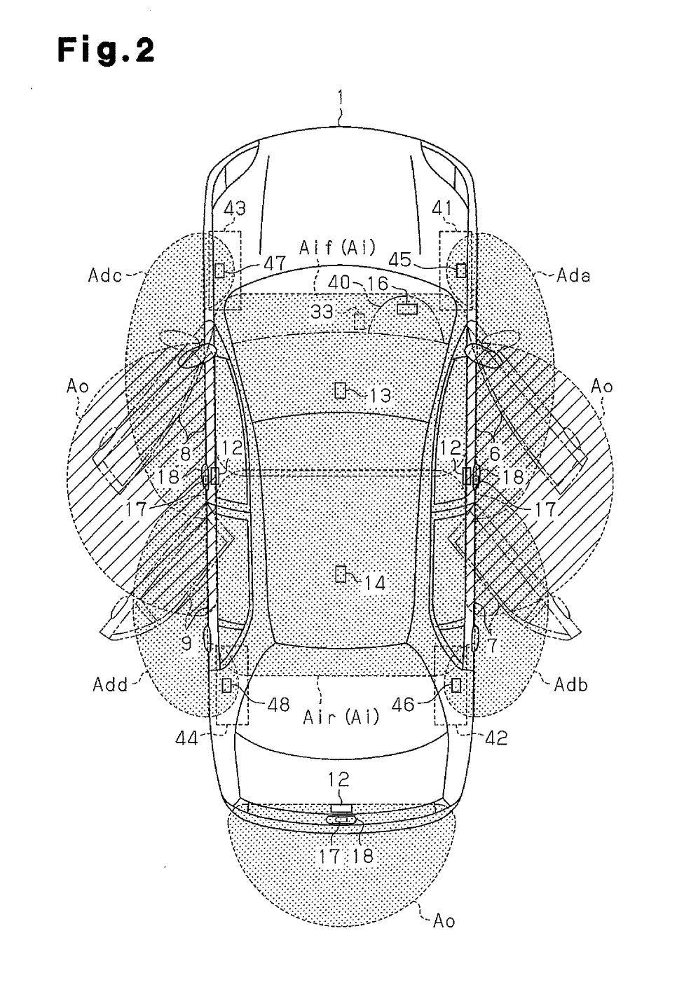

As shown in FIG. 2, when the doors 6, 7, 8, and 9 are open and each of the vehicle interior LF transmitters 13 and 14 transmits the activation signal Swk, the activation signal Swk emanates from the vehicle 1 and forms communication areas Ada, Adb, Adc, and Add. For example, when the right front door 6 is open and the front vehicle interior LF transmitter 13 transmits the activation signal Swk, the right front door communication area Ada is formed including the surrounding of the open right front door 6 and the right front tire 41. When the right rear door 7 is open and the rear vehicle interior LF transmitter 14 transmits the activation signal Swk, the right rear door communication area Adb is formed including the surrounding of the open right rear door 7 and the right rear tire 42. When the left front door 8 is open and the front vehicle interior LF transmitter 13 transmits the activation signal Swk, the left front door communication area Adc is formed including the surrounding of the open left front door 8 and the left front tire 43. When the left rear door 9 is open and the rear vehicle interior LF transmitter 14 transmits the activation signal Swk, the right rear door communication area Add is formed including the surrounding of the open left rear door 9 and the left rear tire 44.

As shown in FIGS. 1A and 1B, the verification ECU 11 includes a tire location determination unit 11d and a valve ID registration unit 11e. When any one of the doors opens, based on the location of the open door and the received detection signal Stp, the tire location determination unit 11d determines the location of the tire corresponding to the valve ID in the detection signal Stp. Based on the tire location determined by the tire location determination unit 11d, the valve ID registration unit 11e registers the valve ID (IDa, IDb, IDc, and IDd) in association with the corresponding one of the tires 41, 42, 43, and 44. The tire location determination unit 11d and the valve ID registration unit 11e configure an example of a registration control circuit.

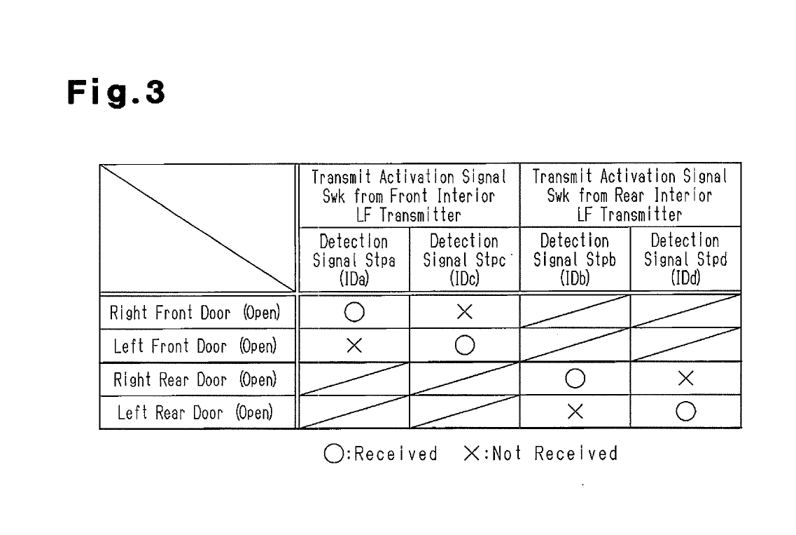

As shown in FIG. 3, in a state in which the right front door 6 is open, the verification ECU 11 transmits an activation signal Swk from the front vehicle interior LF transmitter 13 and receives a detection signal Stpa, which is transmitted from the right front tire valve 45 in response to the activation signal Swk. In a state in which the left front door 8 is open, the verification ECU 11 transmits an activation signal Swk from the front vehicle interior LF transmitter 13 and receives a detection signal Stpc, which is transmitted from the left front tire valve 47 in response to the activation signal Swk. When the right front door 6 or the left front door 8 opens, the verification ECU 11 does not transmit an activation signal Swk from the rear vehicle interior LF transmitter 14.

In a state in which the right rear door 7 is open, the verification ECU 11 transmits an activation signal Swk from the rear vehicle interior LF transmitter 14 and receives a detection signal Stpb, which is transmitted from the right rear tire valve 46 in response to the activation signal Swk. In a state in which the left rear door 9 is open, the verification ECU 11 transmits an activation signal Swk from the rear vehicle interior LF transmitter 14 and receives a detection signal Stpd, which is transmitted from the left rear tire valve 48 in response to the activation signal Swk. When the right rear door 7 or the left rear door 9 opens, the verification ECU 11 does not transmit an activation signal Swk from the front vehicle interior LF transmitter 13.

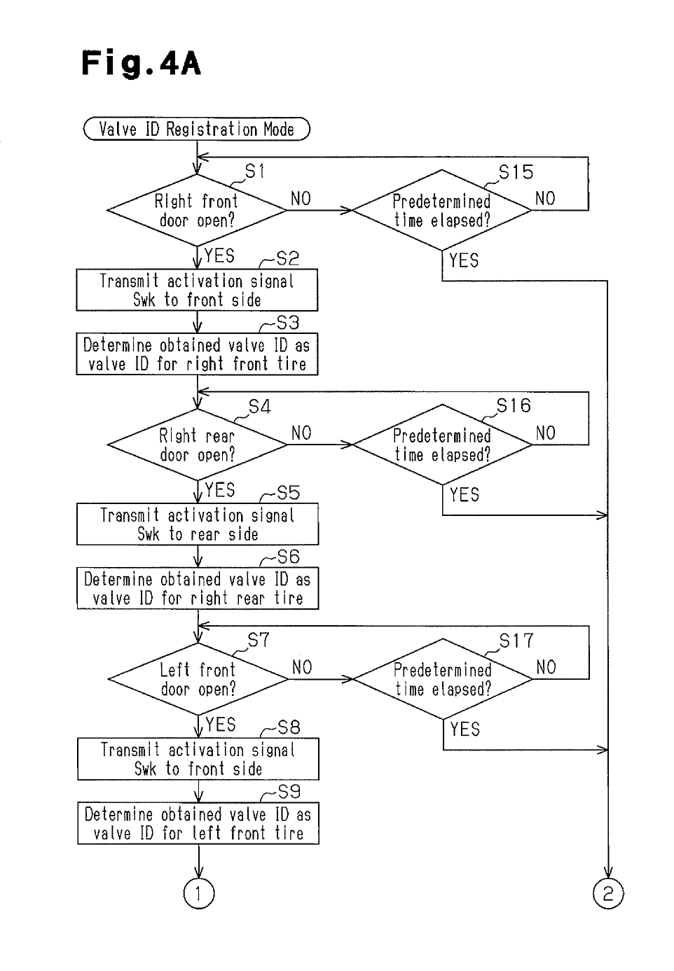

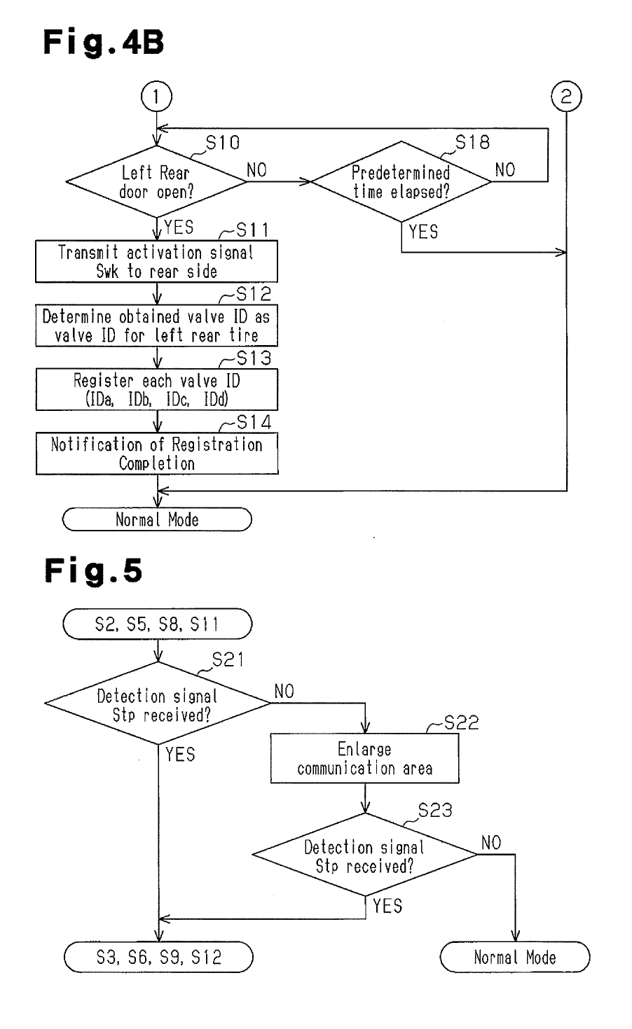

The registration of the valve ID will now be described with reference to FIGS. 4A and 4B.

The verification ECU 11 is operated in modes including a normal mode, in which communication is performed with the electronic key 2 and the tire valves 45, 46, 47, and 48, and a valve registration mode, in which a valve ID is registered. When registration of a predetermined tire location is started, the verification ECU 11 switches from the normal mode to the valve registration mode and starts the registration. As shown in FIGS. 4A and 4B, in the valve registration mode, when the doors 6, 7, 8, and 9 open, the verification ECU 11 transmits an activation signal Swk and receives a detection signal Stp from a tire valve.

The verification ECU 11 determines whether the right front door 6 is open (step S1). That is, the door sensor 11b of the verification ECU 11 determines whether the main body ECU 31 is provided with an open door signal from the right front door courtesy lamp switch 36. When the door sensor 11b determines that the right front door 6 is closed (step S1: NO), the verification ECU 11 proceeds to step S15. The verification ECU 11 determines whether a predetermined time has elapsed since switching to the valve registration mode (step S15). When the predetermined time has not elapsed (step S15: NO), the verification ECU 11 proceeds to step S1. When the predetermined time has elapsed (step S15: YES), the verification ECU 11 ends the valve registration mode and returns to the normal mode.

When the right front door 6 is open (step S1: YES), the verification ECU 11 transmits an activation signal Swk to the front side of the vehicle interior (step S2). That is, the signal transmission instruction unit 11c transmits an activation signal Swk from the front vehicle interior LF transmitter 13. Since the right front door 6 is open, the activation signal Swk forms the front vehicle interior verification communication area Aif and the right front door communication area Ada (refer to FIG. 2).

Among the tires of the vehicle 1, only the right front tire 41 is included in the right front door communication area Ada. Thus, only the right front tire valve 45 can respond to the activation signal Swk. Accordingly, the verification ECU 11 determines that the valve ID (IDa) in the detection signal Stp returned in response to the activation signal Swk is the valve ID for the tire valve 45 of the right front tire 41 (step S3). In other words, the tire location determination unit 11d determines that the detection signal Stpa received by the UHF receiver 15 when the right front door 6 is open has been sent from the right front tire valve 45 of the right front tire 41.

Then, in the same manner as the right front door 6, the verification ECU 11 determines whether the right rear door 7 is open (step S4). When the right rear door 7 is open (step S4: YES), the verification ECU 11 transmits an activation signal Swk to the rear side of the vehicle interior (step S5). The tire location determination unit 11d determines that the detection signal Stpb received by the UHF receiver 15 when the right rear door 7 is open has been sent from the right rear tire valve 46 of the right rear tire 42 (step S6). When the right rear door 7 is closed (step S4: NO), the verification ECU 11 determines whether a predetermined time has elapsed since obtaining the valve ID (IDa) of the right front tire 41 (step S16). When the predetermined time has not elapsed (step S16: NO), the verification ECU 11 proceeds to step S4. When the predetermined time has elapsed (step S16: YES), the verification ECU 11 ends the valve registration mode and returns to the normal mode.

Then, in the same manner as the right front door 6, the verification ECU 11 determines whether the left front door 8 is open (step S7). When the left front door 8 is open (step S7: YES), the verification ECU 11 transmits an activation signal Swk to the front side of the vehicle interior (step S8). The tire location determination unit 11d determines that the detection signal Stpc received by the UHF receiver 15 when the left front door 8 is open has been sent from the left front tire valve 47 of the left front tire 43 (step S9). When the left front door 8 is closed (step S7: NO), the verification ECU 11 determines whether a predetermined time has elapsed since obtaining the valve ID (IDa) of the right front tire 41 (step S17). When the predetermined time has not elapsed (step S17: NO), the verification ECU 11 proceeds to step S4. When the predetermined time has elapsed (step S17: YES), the verification ECU 11 ends the valve registration mode and returns to the normal mode.

Then, in the same manner as the right front door 6, the verification ECU 11 determines whether the left rear door 9 is open (step S10). When the left rear door 9 is open (step S10: YES), the verification ECU 11 transmits an activation signal Swk to the rear side of the vehicle interior (step S11). The tire location determination unit 11d determines that the detection signal Stpd received by the UHF receiver 15 when the left rear door 9 is open has been sent from the left rear tire valve 48 of the left rear tire 44 (step S12). When the left rear door 9 is closed (step S10: NO), the verification ECU 11 determines whether a predetermined time has elapsed since obtaining the valve ID (IDa) of the right front tire 41 (step S18). When the predetermined time has not elapsed (step S18: NO), the verification ECU 11 proceeds to step S4. When the predetermined time has elapsed (step S18: YES), the verification ECU 11 ends the valve registration mode and returns to the normal mode.

When the doors 6, 7, 8, and 9 are open, the verification ECU 11 obtains the valve IDs of the corresponding tire valves 45, 46, 47, and 48 and registers the valve IDs (IDa, IDb, IDc, and IDd) to the memory 11a. Upon completion of the registration of the valve IDs (IDa, IDb, IDc, and IDd) of all of the tires 41, 42, 43, and 44, the verification ECU 11 indicates the registration completion on the display 19. In this manner, the user or the like is notified of the registration completion (step S14). The verification ECU may notify the user of the registration completion with a speaker or a buzzer.

In the valve identification information registration system 5, when a door is open, the vehicle interior LF transmitters 13 and 14 transmit an activation signal Swk, and the activation signal Swk emanates from the vehicle 1 from the open door. The leaked activation signal Swk selectively activates the tire valve that is located in the vicinity of the open door. Based on the detection signal Stp transmitted from the activated tire valve, the valve identification information registration system 5 determines a tire location. In the illustrated example, the LF transmitters 13 and 14, the number of which is less than the number of the tire valves 45, 46, 47, and 48, are used to register the valve IDs. Thus, the valve IDs can be registered with a small number of LF transmitters.

The vehicle interior LF transmitters 13 and 14, which are used by the electronic key system 3, transmit the activation signal Swk. This allows for a significant reduction in the number of transmitters used by the electronic key system 3 and the tire pressure monitoring system 4 (valve identification information registration system 5). Further, the valve IDs can be registered as long as there is at least one LF transmitter inside the vehicle 1.

The present embodiment has the advantages described below.

(1) When the doors 6, 7, 8, and 9 open, the vehicle interior LF transmitters 13 and 14 transmit an activation signal Swk. The UHF receiver 15 then receives a detection signal, which is transmitted in response to the activation signal Swk leaked out of the vehicle 1 from the open doors 6, 7, 8, and 9. Based on the location of the open door, the tire location determination unit lid determines the locations of the tires 41, 42, 43, and 44 corresponding to the valve ID of the received detection signal. Based on the determination, the valve ID registration unit 11e registers the valve ID in association with the corresponding one of the tires 41, 42, 43, and 44. Accordingly, the number of the vehicle interior LF transmitters 13 and 14 that transmit the activation signal Swk can be less than the number of the tires 41, 42, 43, and 44. Thus, a transmitter that transmits an activation signal does not have to be provided for each of the doors 6, 7, 8, and 9. In this manner, the number of transmitters that activate the tire valves can be reduced when registering the valve IDs. Thus, fewer components are required to determine a tire location and register the identification information of a tire valve.

(2) The transmitters that transmit an activation signal Swk include the vehicle interior LF transmitters 13 and 14, which are respectively arranged in the front side and rear side of the vehicle interior. The activation signal Swk can be transmitted to the front side and rear side of the vehicle 1. Thus, the tire location determination unit lid can determine tire locations with higher accuracy.

(3) The vehicle interior LF transmitters 13 and 14, which transmit a request signal Srq used by the electronic key system 3, transmit an activation signal Swk. Thus, there is no need to add a transmitter dedicated for the registration of the valve IDs (IDa, IDb, IDc, and IDd) used by the tire pressure monitoring system 4. As long as the vehicle 1 includes the electronic key system 3, the transmitters of the electronic key system 3 can be used to register the tire locations. Thus, the valve IDs (IDa, IDb, IDc, and IDd) can be registered without increasing the number of transmitters.

It should be apparent to those skilled in the art that the present invention may be embodied in many other specific forms without departing from the spirit or scope of the invention. Particularly, it should be understood that the present invention may be embodied in the following forms.

In the above embodiment, the valve registration mode of the verification ECU 11 may notify the user of the door that should be opened. For example, the door that should be opened may be notified by a notification device such as the display 19 or a speaker.

In the above embodiment, during valve ID registration, the valve IDs are obtained and registered in the order of the right front door 6, the right rear door 7, the left front door 8, and the left rear door 9. However, this order does not have to be predetermined. For example, the valve IDs can be obtained in order from the doors that are opened, and the valve IDs may be registered when the valve IDs of all of the tires are obtained.

In the above embodiment, the activation signal Swk used by the valve identification information registration system 5 is transmitted to the vehicle interior verification communication area Ai, which is used by the electronic key system 3. However, the transmission range of the activation signal Swk may be larger than the vehicle interior verification communication area Ai. For example, the verification ECU 11 may include a communication area formation unit 11f, which changes the size of the communication areas formed by the front vehicle interior LF transmitter 13 and the rear vehicle interior LF transmitter 14 between vehicle interior verification and valve ID registration. The communication area formation unit 11f forms relatively small communication areas with the vehicle interior LF transmitters 13 and 14 during vehicle interior verification and forms relatively large communication areas with the vehicle interior LF transmitters 13 and 14 during valve ID registration.

During vehicle interior verification, the vehicle interior LF transmitters 13 and 14 transmit a request signal Srq with a relatively weak output to form the vehicle interior verification communication area Ai (refer to FIG. 2). During valve ID registration, the vehicle interior LF transmitters 13 and 14 transmit a request signal Srq with a relatively strong output to form a communication area that is larger than the vehicle interior verification communication area Ai (Aif and Air). This forms communication areas that sufficiently include tire wells in the vicinity of the open doors 6, 7, 8, and 9. The vehicle interior verification communication area Ai may be referred to as a key communication area. The communication area that is larger than the vehicle interior verification communication area Ai may be referred to as a valve communication area.

In this structure, the valve communication area, to which the activation signal Swk is transmitted, is larger than the key communication area Ai, to which the request signal Srq that is a wireless signal of the electronic key system 3 is transmitted. Thus, a communication area having a size required for an activation signal Swk to sufficiently reach a tire valve is formed, and power consumption can be reduced.

Depending on the radio wave situation, a detection signal Stp, which is transmitted in response to an activation signal Swk, may not be received. In such a case, the vehicle interior LF transmitters 13 and 14 may re-transmit the activation signal Swk.

When re-transmitting the activation signal Swk from the vehicle interior LF transmitters 13 and 14, as described above, a communication area that is larger than the vehicle interior verification communication area Ai is formed. More specifically, as shown in FIG. 5, when an activation signal Swk is transmitted in steps S2, S5, S8, and S11, the verification ECU 11 determines whether a detection signal Stp has been received (step S21). When the detection signal Stp has been received (step S21: YES), the verification ECU 11 proceeds to steps S3, S6, S9, and S12. When the detection signal Stp is not received (step S21* NO), the verification ECU 11 transmits an activation signal Swk from the vehicle interior LF transmitters 13 and 14 with the communication area formation unit 11f to the communication area that is larger than the vehicle interior verification communication area Ai (step S22). Then, the verification ECU 11 determines whether a detection signal Stp has been received (step S23). When the detection signal Stp is received (step S23: YES), the verification ECU 11 proceeds to steps S3, S6, S9, and S12. When the detection signal Stp is not received (step S23: NO), the verification ECU 11 ends the valve registration mode and returns to the normal mode. The communication area may be repetitively enlarged a number of times as long as two or more tire valves do not transmit the detection signal Stp.

In this configuration, the activation signal Swk is first transmitted to a relatively small communication area. This reduces power consumption. The re-transmitted activation signal Swk is transmitted to the valve communication area, which is larger than the key communication area. This ensures that the activation signal Swk reaches the tire valve.

When two doors are open at the same time, it is preferred that the registration process be invalidated or disabled. This avoids erroneous registration of the valve IDs included in detection signals Stp transmitted at substantially the same time from two valves.

In the above embodiment, the timing for starting registration of the valve ID can be changed. Further, the registration of the valve ID can be started in response to a predetermined operation.

In the above embodiment, instead of the plurality of LF transmitters that transmit a wireless signal to the front and rear sides of the vehicle interior, a single LF transmitter may transmit a wireless signal to the vehicle interior.

The number of the LF transmitters is not limited to two, and three or more LF transmitters may be used to transmit a wireless signal to the vehicle interior. When registering a valve ID, it is desirable that a wireless signal be transmitted from an LF transmitted located in the vehicle 1 near the door that opens.

In the above embodiment, the electronic key system 3 includes LF transmitters respectively corresponding to vehicle interior verification and vehicle exterior verification.

In the above embodiment, the activation signal Swk differs from the request signal Srq. However, as long as either one of the request signal Srq and the activation signal Swk is transmitted, the electronic key 2 and tire valve may respectively return the ID code signal Sid and the detection signal Stp. In this case, it is desirable that the transmission timings of the tire valves 45, 46, 47, and 48 be shifted. Since the activation signal Swk and request signal Srq are used in common, the vehicle 1 does not have to separately transmit the activation signal Swk and the request signal Srq. This simplifies the control of the wireless signals (Swk and Srq).

In the above embodiment, the wireless signals transmitted from the tire valves 45, 46, 47, and 48 during valve ID registration does not have to include the air pressure information as long as the valve ID is included.

In the above embodiment, the location of the vehicle exterior LF transmitter 12 can be changed as long as the desired vehicle exterior communication area Ao can be formed.

In the above embodiment, the valve identification information registration system 5 uses the vehicle interior LF transmitters 13 and 14 of the electronic key system 3. However, a separate LF transmitter (e.g., initiator) dedicated for the valve identification information registration system 5 may be used.

In the above embodiment, a wireless signal may have a frequency other than LF and UHF. The frequency of the wireless signal transmitted from the vehicle 1 and the frequency of the wireless signal returned to the electronic key 2 may be different or the same.

In the above embodiment, the electronic key system 3 and the tire pressure monitoring system 4 share the same control unit. However, the tire pressure monitoring system 4 (valve identification information registration system 5) and the electronic key system 3 may include separate control units.

The tire pressure monitoring system 4 and the electronic key system 3 may include different reception units.

In the above embodiment, the electronic key system 3 may be eliminated.

The present examples and embodiments are to be considered as illustrative and not restrictive, and the invention is not to be limited to the details given herein, but may be modified within the scope and equivalence of the appended claims.

1. A valve identification information registration system that registers identification information of a tire valve of a vehicle to a controller for a tire pressure monitoring system of the vehicle, the valve identification information registration system comprising:
a door sensor that detects an open state and closed state of a door of the vehicle;
a transmitter arranged in an interior of a vehicle, wherein the transmitter transmits a tire valve activation signal in response to a detection of the door sensor indicating that the door is in the open state; and
a registration control circuit that receives a wireless response signal transmitted from the tire valve activated by the tire valve activation signal, which emanates from the vehicle interior from the open door, wherein the registration control circuit registers the identification information of the tire valve, which is included in the received wireless response signal in association with a tire location corresponding to the detection of the door sensor.

2. The valve identification information registration system according to claim 1, wherein
the transmitter includes a front transmitter, which transmits the tire valve activation signal to a front side of the vehicle interior, and a rear transmitter, which transmits the tire valve activation signal to a rear side of the vehicle interior, and
the registration control circuit transmits the tire valve activation signal from the front transmitter or the rear transmitter in accordance with the location of the open door and determines the location of the tire based on the wireless response signal transmitted from the tire valve, which is activated by the tire valve activation signal.

3. The valve identification information registration system according to claim 1, wherein the transmitter is used as a transmitter for an electronic key system that controls a vehicle on-board device through wireless communication performed between the vehicle and a communication terminal.

4. The valve identification information registration system according to claim 3, wherein
the valve identification information registration system operates in a normal mode, in which wireless communication is performed with the communication terminal, and a valve registration mode, in which the identification information of the tire valve is registered,
the valve identification information registration system further comprises a communication area formation unit,
in the normal mode, the communication area formation unit transmits the tire valve activation signal from the transmitter to a relatively small key communication area, and
in the valve registration mode, the communication area formation unit transmits the tire valve activation signal from the transmitter to a valve communication area that is larger than the key communication area.

5. The valve identification information registration system according to claim 3, further comprising a communication area formation unit, wherein when the transmitter transmits the tire valve activation signal but the registration control circuit does not receive the wireless response signal from the tire valve, the communication area formation unit re-transmits the tire valve activation signal to a valve communication area that is larger than a key communication area of the electronic key system.

6. The valve identification information registration system according to claim 3, wherein the tire valve activation signal is also used as a wireless signal for the wireless communication performed between the vehicle and the communication terminal.

7. The valve identification information registration system according to claim 1, further comprising a plurality of transmitters including the transmitter,
wherein when the door sensor detects the open state of the door, one of the transmitters that corresponds to the door is the transmitter that transmits the tire valve activation signal.

8. A valve identification information registration system comprising:
a door sensor that detects an open state and closed state of a vehicle door;
a transmitter arranged in an interior of a vehicle, wherein the transmitter transmits a tire valve activation signal in response to a detection of the door sensor indicating that the door is in the open state;
a tire valve attached to a tire of the vehicle, wherein the tire valve is activated by the tire valve activation signal, which emanates from the vehicle interior from the open door, and transmits a wireless response signal including identification information; and
a registration control circuit that receives the wireless response signal transmitted from the tire valve and registers the identification information of the tire valve, which is included in the received wireless response signal, in association with a tire location corresponding to the detection of the door sensor.

9. The valve identification registration system according to claim 8, wherein
the vehicle includes a plurality of tires, and
the tire valve activation signal that emanates from the open door forms a communication area that covers the tire associated with the door but does not cover the other tires.
